(19) United States
(12) Patent Application Publication
(10) Pub. No.: US 2020/0174278 A1
(43) Pub. Date: Jun. 4, 2020

(54) DISPLAY DEVICE AND THREE-DIMENSIONAL DISPLAY METHOD THEREFOR

(71) Applicant: BOE Technology Group Co., Ltd., Beijing (CN)

(72) Inventors: Jinye ZHU, Beijing (CN); Chen-Yu CHEN, Beijing (CN); Ming YANG, Beijing (CN); Wenqing ZHAO, Beijing (CN)

(21) Appl. No.: 16/613,247

(22) PCT Filed: Mar. 29, 2019
(86) PCT No.: PCT/CN2019/080639

§ 371 Date: Nov. 13, 2019

(30) Foreign Application Priority Data
Mar. 30, 2018 (CN) 201810276893.0

(51) Int. Cl. G02B 30/26; G02B 27/00; G09G 3/20; H04N 13/31

(52) U.S. Cl. CPC G02B 30/26; G02B 27/0018; G09G 2300/0452; H04N 13/31; G09G 2300/0404; G09G 3/2074

(57) ABSTRACT

A display device and a three-dimensional display method therefor, wherein a display panel is internally provided with sub-pixels and black matrices that are alternately arranged, and in each two adjacent columns of sub-pixels, sides of each sub-pixel and black matrix connected in the column direction are aligned in the same longitudinal straight line. In a three-dimensional display mode, at least every two columns of sub-pixels are a view area, and adjacent view areas are used for providing gray-scale information of different view images; and in the three-dimensional display mode, a three-dimensional grating forms light-transmitting areas and light-blocking areas that are alternately arranged in the row direction

This application is a National Stage of International Application No. PCT/CN2019/080639, filed on Mar. 29, 2019, which claims priority to Chinese Patent Application No. 201810276893.0, filed with the Patent Office of the People's Republic of China on Mar. 30, 2018, and entitled “THREE-DIMENSIONAL DISPLAY DEVICE AND THREE-DIMENSIONAL DISPLAY METHODS THEREFOR”, both of which are incorporated in this application by reference in their entireties.

### FIELD

The disclosure relates to the technical field of naked eye three-dimensional display and in particular relates to a display device and three-dimensional display methods therefor.

### BACKGROUND

At present, when a naked eye three-dimensional display device is viewed, a relatively serious moire effect problem exists, namely black and white stripes can be seen. Particularly, the moire effect can correspondingly move and cannot be eliminated when a viewer moves back and forth, and thus, the watching effect of three-dimensional display is greatly affected.

### SUMMARY

Some embodiments of the disclosure provide a display device including a display panel and a three-dimensional grating arranged at the light emergent side of the display panel; wherein

the display panel includes a plurality of pixels and black matrixes, and the pixels include a plurality of sub-pixels; and the sub-pixels and the black matrixes are alternately arranged in both row and column directions;

in every column of sub-pixels, sides, connected in the column direction, of the sub-pixels and the adjacent black matrixes are aligned to a same straight line;

a view region of the display panel includes at least two adjacent columns of sub-pixels, and adjacent view regions are respectively configured to display three-dimensional image information corresponding to different viewpoints;

and the three-dimensional grating is configured to form light transmitting regions and light blocking regions alternately arranged in the row direction.

On the other hand, some embodiments of the disclosure further provide a three-dimensional display method of the display device, including:

controlling the adjacent view regions in the display panel to display the three-dimensional image information corresponding to different viewpoints, and controlling the three-dimensional grating to form the light transmitting regions and the light blocking regions; and changing the positions of the light transmitting regions and the light blocking regions in the three-dimensional grating according to a movement of a viewer.

On another hand, some embodiments of the disclosure further provide another three-dimensional display method of the display device, including:

controlling the adjacent view regions in the display panel to display the three-dimensional image information corresponding to different viewpoints, and controlling the three-dimensional grating to form the light transmitting regions and the light blocking regions, wherein the positions of the light transmitting regions and the light blocking regions are fixed; and changing positions of the view regions in the display panel according to a movement of a viewer.

### BRIEF DESCRIPTION OF THE DRAWINGS

FIG. 1 is a structural schematic diagram of a display device provided by some embodiments of the disclosure;

FIG. 2a and FIG. 2b are respectively structural schematic diagrams of a display panel in the display device provided by some embodiments of the disclosure;

FIG. 3a is a schematic diagram of the display panel in the display device provided by some embodiments of the disclosure under a three-dimensional display condition;

FIG. 3b is a schematic diagram of the display panel in the display device provided by some embodiments of the disclosure under a two-dimensional display condition;

FIG. 4 is a partial enlarged drawing of a dotted box in FIG. 2a;

FIG. 5 is a schematic diagram of wiring in the display panel in the display device provided by some embodiments of the disclosure;

FIG. 6a is a principle schematic diagram of a related display device;

FIG. 6b to FIG. 6d are respectively principle diagrams of the display device provided by some embodiments of the disclosure;

FIG. 7 is a schematic diagram of a three-dimensional grating in the display device provided by some embodiments of the disclosure.

### DETAILED DESCRIPTION OF THE EMBODIMENTS

In order to make the objectives, technical solutions and advantages of the disclosure clearer, the disclosure is further described in detail below in conjunction with accompanying drawings, obviously, the described embodiments are a part of embodiments of the disclosure, not all the embodiments. Based on the embodiments of the disclosure, all other embodiments obtained by those of ordinary skill in the art without creative work shall fall within the protection scope of the disclosure.

The shape and size of each part in the accompanying drawings do not reflect a true proportion and are only intended to explain the content of the disclosure.

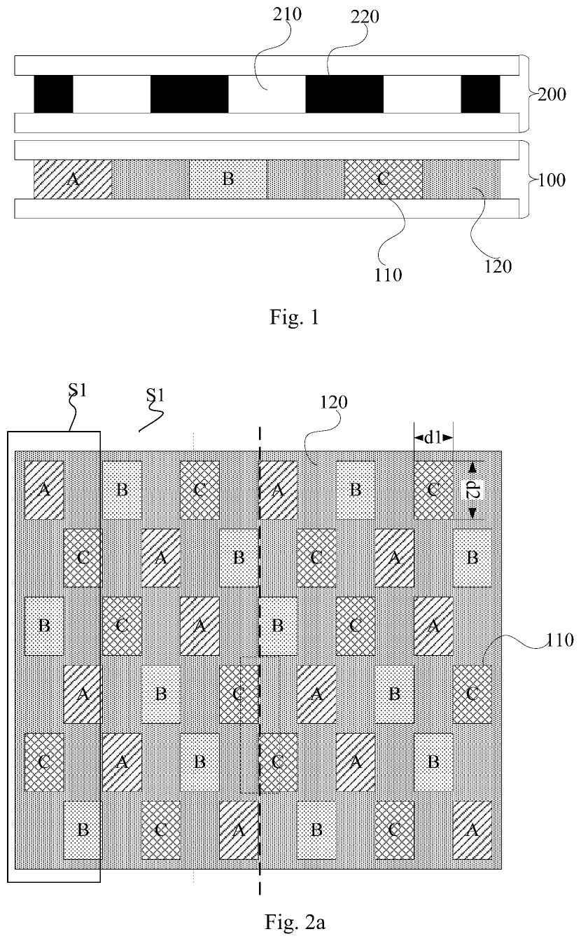

The display device provided by some embodiments of the disclosure, as shown in FIG. 1, includes a display panel 100 and a three-dimensional grating 200 arranged at the light emergent side of the display panel 100.

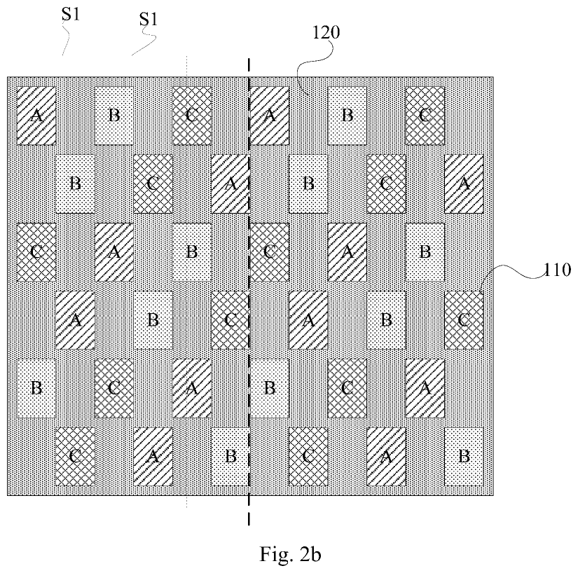

As shown in FIG. 2a and FIG. 2b, the display panel 100 includes a plurality of pixels and black matrixes 120, wherein the pixels include a plurality of sub-pixels 110; and the sub-pixels 110 and the plurality of black matrixes 120 are alternately arranged in both row and column directions.

As shown in FIG. 2a and FIG. 2b, in every column of sub-pixels 110, the sides, connected in the column direction, of the sub-pixels 110 and the adjacent black matrixes 120 are aligned to the same straight line (shown as a dotted line in the figure).

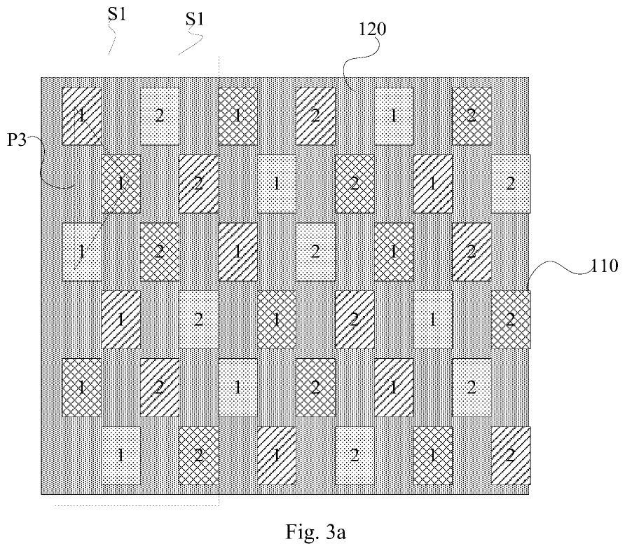

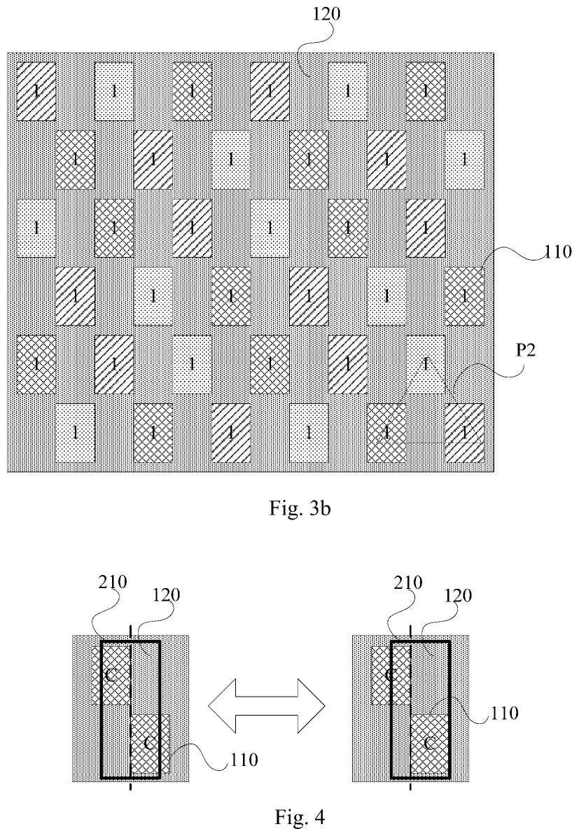

As shown in FIG. 3a, each view region S1 of the display panel 100 is composed of at least two columns of sub-pixels 110, and the adjacent view regions S1 are respectively configured to display three-dimensional image information corresponding to different viewpoints; and “1” and “2” denote the three-dimensional image information corresponding to the different viewpoints in FIG. 3.

As shown in FIG. 1, the three-dimensional grating 200 is configured to form light transmitting regions 210 and light blocking regions 220 alternately arranged in the row direction.

Alternatively, in the display device provided by some embodiments of the disclosure, the sub-pixels 110 and the plurality of black matrixes 120 are alternately arranged in both the row and column directions in the display panel 100; in addition, in every column of sub-pixels 110, the sides, connected in the column direction, of the sub-pixels 110 and the adjacent black matrixes 120 are aligned to the same straight line, so that a light shading gap cannot exist between the adjacent columns of sub-pixels 110. As shown in FIG. 4, it is ensured that a dark region area formed by the total area of the black matrixes 120 corresponding to each of the light transmitting regions 210 is unchanged and a bright region area formed by the total area of the sub-pixels 110 corresponding to each of the light transmitting regions 210 is also unchanged in the three-dimensional grating 200 arranged at the light emergent side of the display panel 100 when a viewer moves, and therefore, the moiré effect cannot be seen.

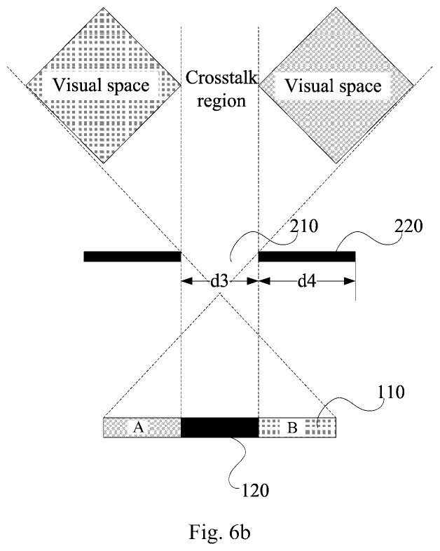

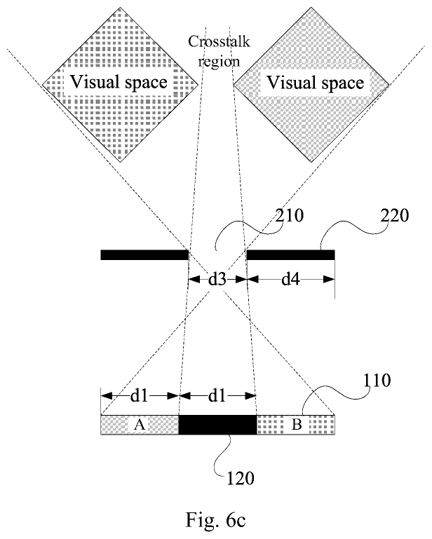

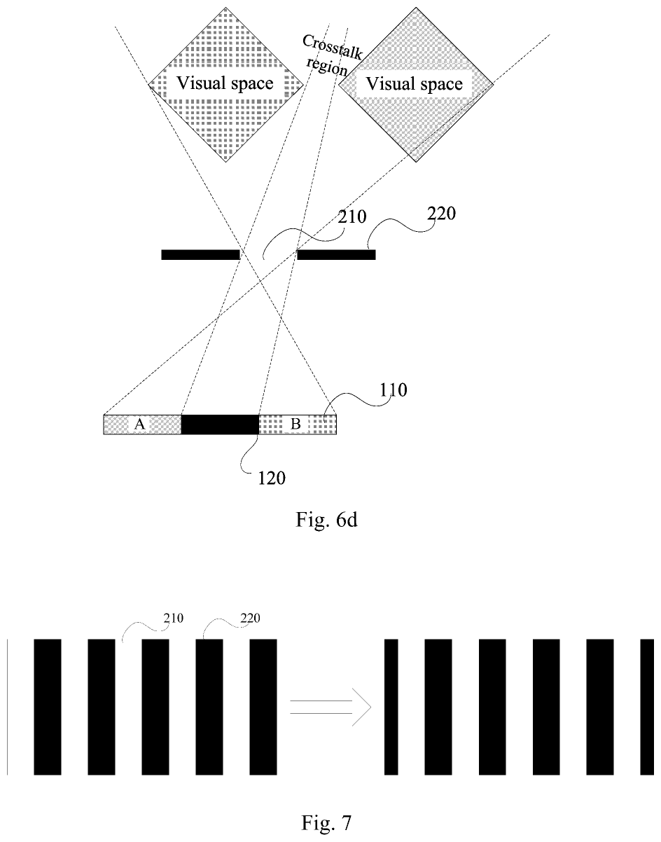

Alternatively, in the display device provided by some embodiments of the disclosure, the light shading gap cannot exist between the adjacent columns of sub-pixels 110, as shown in FIG. 2a, so that the widths d1 of the black matrixes 120 and the sub-pixels 110 in the row direction are consistent, with respect to black matrixes in a current display device as shown in FIG. 6a, the area of the black matrixes 120 is increased as shown in FIG. 6b, the crosstalk region between the adjacent visual spaces can be reduced, the area of the unit visual space can be increased, furthermore, the continuity of the overall visual spaces is guaranteed, the viewer cannot exceed the range of the visual spaces in a movement process, namely a jumping three-dimensional view cannot be seen, and the three-dimensional viewing comfort level is improved.

Alternatively, in the display device provided by some embodiments of the disclosure, as shown in FIG. 3a, each of the view regions S1 includes two adjacent columns of sub-pixels 110 in a three-dimensional display mode, and the adjacent view regions S1 are respectively configured to display three-dimensional image information corresponding to a left-eye viewpoint and three-dimensional image information corresponding to a right-eye viewpoint. “1” and “2” respectively denote the three-dimensional image information corresponding to the left-eye viewpoint and the three-dimensional image information corresponding to the right-eye viewpoint in FIG. 3a, and the two columns of sub-pixels 110 in the same view region S1 display the three-dimensional image information corresponding to the same viewpoint.

Alternatively, in the display device provided by some embodiments of the disclosure, every three adjacent columns of sub-pixels or more than three columns of sub-pixels may also form a view region in the three-dimensional display mode, there are no limits herein. In addition, the number of the viewpoints may also be larger than 2, so that multi-viewpoint three-dimensional display is realized.

Alternatively, in the display device provided by some embodiments of the disclosure, as shown in FIG. 2a and FIG. 2b, the light emitting colors of the sub-pixels 110 adjacent in the row direction are different from each other; and the light emitting colors of the sub-pixels 110 adjacent in the column direction are also different from each other, and A, B and C denote the different light emitting colors of the sub-pixels 110 in the figure.

Alternatively, the colors of the sub-pixels 110 adjacent in the row direction are set to be different from each other, and the color of the sub-pixels 110 adjacent in the column direction are set to be different from each other, so that it can be ensured that the sub-pixels 110 with all the light emitting colors are relatively uniformly distributed in three-dimensional and two-dimensional display modes, which is beneficial to the display uniformity.

Alternatively, in the display device provided by some embodiments of the disclosure, as shown in FIG. 2a and FIG. 2b, each row of sub-pixels 110 includes sub-pixels 110 with all the light emitting colors, for example, each row of sub-pixels 110 includes sub-pixels 110 with the three light emitting colors A, B and C.

The sub-pixels 110 with different light emitting colors in each row of sub-pixels 110 are repeatedly arranged according to the same order, for example, as shown in FIG. 2a, the light emitting colors of the sub-pixels 110 in the first row of sub-pixels 110 are repeatedly arranged according to the order of A, B and C from left to right; the light emitting colors of the sub-pixels 110 in the second row of sub-pixels 110 are repeatedly arranged according to the order of C, A and B from left to right; and the light emitting colors of the sub-pixels 110 in the third row of sub-pixels 110 are repeatedly arranged according to the order of B, C and A from left to right. The sub-pixels 110 with different light emitting colors in each column of sub-pixels 110 are repeatedly arranged according to the same order; for example, as shown in FIG. 2a, the light emitting colors of the sub-pixels 110 in the first column of sub-pixels 110 are repeatedly arranged according to the order of A, B and C from top to bottom; the light emitting colors of the sub-pixels 110 in the second column of sub-pixels 110 are repeatedly arranged according to the order of C, A and B from top to bottom; and the light emitting colors of the sub-pixels 110 in the third column of sub-pixels 110 are repeatedly arranged according to the order of B, C and A from top to bottom.

Alternatively, FIG. 2a and FIG. 2b merely illustrate the arrangement order of the light emitting colors of the sub-pixels 110, there are no limits herein. In addition, A, B and C may respectively correspond to red, blue and green in the actual application, the descriptions thereof are omitted herein.

Alternatively, the number of the sub-pixels 110 with the same light emitting color in every two adjacent columns of sub-pixels 110 may be kept the same according to the arrangement way of the light emitting colors of the sub-pixels 110 in the display device provided by some embodiments of the disclosure, in this way, as shown in a dotted box enlarged drawing in FIG. 2a, namely as shown in FIG. 4, the areas of the sub-pixels 110 with the same color respectively in two columns of sub-pixels 110 in the display panel 100 on a corresponding position of the light transmitting regions 210 may be complemented with each other, and similarly, the areas of the black matrixes 120 located on the two columns of sub-pixels 110 in the display panel 100 on the corresponding position of the light transmitting regions 210 may also be complemented with each other. In a process that the viewer moves, namely from a left view to a right view of FIG. 4, it is ensured that the seen bright region area formed by the sub-pixels 110 and the seen dark region area formed by the black matrixes 120 are always kept unchanged, and therefore, the moiré effect cannot be seen.

Alternatively, in the display device provided by some embodiments of the disclosure, as shown in FIG. 3a, in the three-dimensional display mode, each of three-dimensional display pixel points P3 is composed of three sub-pixels 110 with different light emitting colors (different filling patterns in FIG. 3a denote the different light emitting colors), which are arranged in three adjacent rows of sub-pixels 110 and two adjacent columns of sub-pixels 110, and the three-dimensional display pixel points P3 are configured to display three-dimensional image information.

As shown in FIG. 3b, in a two-dimensional display mode, each two-dimensional display pixel point P2 is composed of three sub-pixels with different light emitting colors (different filling patterns in FIG. 3b denote the different light emitting colors), which are arranged in three adjacent columns of sub-pixels 110 and two adjacent rows of sub-pixels 110, and the two-dimensional display pixel points P2 are configured to display two-dimensional image information.

Alternatively, when every two columns of sub-pixels 110 are used as a view region according to a formation way of the three-dimensional display pixel points P3 in the three-dimensional display mode and the adjacent view regions are used for respectively displaying the left-eye viewpoint image and the right-eye viewpoint image, in the column direction, the sub-pixels 110 with the same light emitting colors in the two adjacent three-dimensional display pixel points P3 may be located in different columns, namely, the red sub-pixels are located in different columns, the blue sub-pixels are located in different columns, and the green sub-pixels are located in different columns, for example, if the red sub-pixels in the previous three-dimensional display pixel point P3 are located in the first column, the red sub-pixels in the next three-dimensional display pixel point P3 are located in the second column. In addition, in the column direction, the previous three-dimensional display pixel point P3 and the next three-dimensional display pixel point P3 display the same content, and thus, a display compensation effect can be achieved. In the row direction, the three-dimensional display pixel points P3 adjacent left and right are respectively configured to display the three-dimensional image information corresponding to the different viewpoints.

Alternatively, in the display device provided by some embodiments of the disclosure, as shown in FIG. 2a, the ratio of the width d1 of the sub-pixels 110 in the row direction to the width d2 of the sub-pixels 110 in the column direction may be 2:3.

Alternatively, with a 27-inch display panel as an example, the width d1 of the sub-pixels 110 and the black matrixes 120 in the row direction is 26 μm, the width d2 of the sub-pixels 110 and the black matrixes 120 in the column direction is 39 μm, and the sizes of open regions of the sub-pixels 110 are 26 μm*34 μm. As shown in FIG. 3a, in the three-dimensional display mode, the center-to-center spacing of two three-dimensional display pixel points P3 displaying the same viewpoint image in adjacent rows, namely the point spacing in a horizontal direction is 104 μm, the center-to-center spacing of two three-dimensional display pixel points P3 displaying the same viewpoint image in adjacent columns, namely the point spacing in a vertical direction is 117 μm, and the difference of the point spacing in the horizontal direction and the point spacing in the vertical direction is very small, so that the light emitting density in the three-dimensional display mode is relatively uniform. As shown in FIG. 3b, in the two-dimensional display mode, the center-to-center spacing of two two-dimensional display pixel points P2 displaying the same viewpoint image in adjacent rows, namely the point spacing in a horizontal direction is 78 μm, the center-to-center spacing of two two-dimensional display pixel points P2 displaying the same viewpoint image in adjacent columns, namely the point spacing in a vertical direction is 78 μm, and the point spacing in the horizontal direction and the point spacing in the vertical direction are equal, so that the light emitting density in the two-dimensional display mode is relatively uniform.

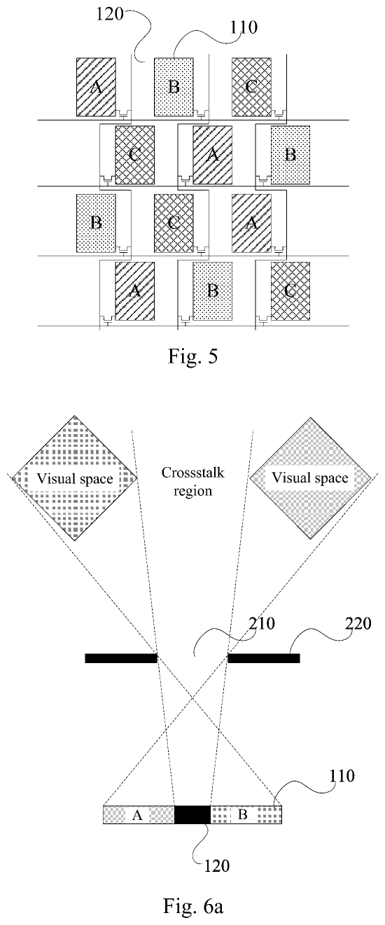

Alternatively, in the display device provided by some embodiments of the disclosure, the display panel 100 may adopt a liquid crystal display panel or an electroluminescent display panel and other display panels, but is not limited herein. In addition, in every column of sub-pixels 110 of the display panel 100, the sides, connected in the column direction, of the sub-pixels 110 and the adjacent black matrixes 120 are aligned to the same straight line, so that a light shading gap cannot exist between the adjacent columns of sub-pixels 110, and furthermore, a signal line in a vertical direction cannot be designed conventionally. Based on this, as shown in FIG. 5, a broken line signal line may be arranged in the display panel so that each of the sub-pixels 110 in the display panel is driven.

Alternatively, in the display device provided by some embodiments of the disclosure, a crosstalk region between adjacent visual spaces can be reduced by increasing the area of the black matrixes 120, so that the continuity of the visual spaces is guaranteed, the viewer cannot see a jumping three-dimensional view in a movement process, and furthermore, the three-dimensional viewing comfort level is improved. In order to further reduce the area of the crosstalk region, the area of the light blocking regions 220 in the three-dimensional grating 200 can also be increased, namely different from the design that the widths of light blocking strips and light transmitting strips in a conventional three-dimensional grating are equal, in the display device provided by some embodiments of the disclosure, as shown in FIG. 6b, the width d3 of each of the light transmitting regions 210 in the row direction may be smaller than the width d4 of each of the light blocking regions 220 in the row direction. By comparison, it can be seen that the area of the crosstalk region can be reduced by increasing the area of the light blocking regions 220 and reducing the area of the light transmitting regions 210.

Alternatively, in the display device provided by some embodiments of the disclosure, as shown in FIG. 6c and FIG. 6d, the width d3 of each of the light transmitting regions 210 in the row direction is also smaller than the width d1 of each of the sub-pixels 110 in the row direction, namely the area of the crosstalk region may be further reduced by further reducing the area of the light transmitting regions 210 and increasing the area of the light blocking regions 220, so that the continuity of the visual spaces is guaranteed, the viewer cannot see the jumping three-dimensional view in the movement process, and the three-dimensional viewing comfort level is improved. FIGS. 6c and 6d respectively show the visual spaces when the viewer is located on different positions in the movement process.

Alternatively, in the display device provided by some embodiments of the disclosure, the three-dimensional grating 200 may adopt a liquid crystal grating or an electrochromic grating, but is not limited herein. In addition, in the three-dimensional grating 200, a plurality of control electrodes may be designed as shifting gears of the light blocking regions 220, and due to the control on the electrification of the control electrodes, the strip-shaped light transmitting regions 210 and light blocking regions 220 which are alternately arranged may be formed. As shown in FIG. 7, when the viewer moves (for example, the viewer moves in an arrow direction), the light transmitting regions 210 and the light blocking regions 220 may also correspondingly move by regulating the electrification quantity of the control electrodes, the left view in FIG. 7 is the structure of the three-dimensional grating before movement, and the right view in FIG. 7 is the structure of the three-dimensional grating after movement, and at the moment, the position of the viewpoint image displayed by the display panel 100 is unchanged. In addition, the widths of the control electrodes decide the minimum moving-step length.

Or, in the display device provided by some embodiments of the disclosure, the positions of the light transmitting regions 210 and the light blocking regions 220 in the three-dimensional grating may also be kept unchanged when the viewer moves, the position of the viewpoint image displayed by the display panel 100 is moved, and the minimum moving-step length is the width of the sub-pixels 110 in the row direction.

Based on the same inventive concept, some embodiments of the disclosure further provides a three-dimensional display method of the display device, including:

controlling the adjacent view regions in the display panel to respectively display the three-dimensional image information corresponding to the different viewpoints, and controlling the three-dimensional grating to form the light transmitting regions and the light blocking regions; and meanwhile, changing the positions of the light transmitting regions and the light blocking regions in the three-dimensional grating according to the movement of the viewer.

Alternatively, in the three-dimensional display mode, when the viewer moves, the light transmitting regions and the light blocking regions in the three-dimensional grating may also correspondingly move by regulating the positions of the light transmitting regions and the light blocking regions, and at the moment, the position of the viewpoint image displayed by the display panel is unchanged.

Based on the same inventive concept, some embodiments of the disclosure further provides another three-dimensional display method of the display device, including:

controlling the adjacent view regions in the display panel to respectively display the three-dimensional image information corresponding to the different viewpoints, and controlling the three-dimensional grating to form the light transmitting regions and the light blocking regions of which the positions are fixed; and meanwhile, changing the positions of the view regions in the display panel according to the movement of the viewer.

Alternatively, in the three-dimensional display mode, when the viewer moves, the three-dimensional image information corresponding to the viewpoints displayed by the display panel may also correspondingly move by regulating the position of the three-dimensional image information, and at the moment, the positions of the light transmitting regions and the light blocking regions in the three-dimensional grating are unchanged.

According to the display device and the three-dimensional display methods thereof provided by some embodiments of the disclosure, the sub-pixels and the plurality of black matrixes are alternately arranged in both the row and column directions in the display panel; in addition, in every column of sub-pixels, the sides, connected in the column direction, of the sub-pixels and the adjacent black matrixes are aligned to the same straight line, so that a light shading gap cannot exist between the adjacent columns of sub-pixels, it is ensured that a dark region area formed by the total area of the black matrixes corresponding to each of the light transmitting regions is unchanged and a bright region area formed by the total area of the sub-pixels corresponding to each of the light transmitting regions is also unchanged in the three-dimensional grating arranged at the light emergent side of the display panel in the three-dimensional display mode and a process that the viewer moves, and therefore, the moiré effect cannot be seen. In addition, the light shading gap cannot exist between the adjacent columns of sub-pixels, so that the widths of the black matrixes and the sub-pixels in the row direction are consistent, the area of the black matrixes is relatively increased, the crosstalk region between the adjacent visual spaces can be reduced, the area of the unit visual space can be increased, furthermore, the continuity of the overall visual spaces is guaranteed, the viewer cannot exceed the range of the visual spaces in a movement process, namely a jumping three-dimensional view cannot be seen, and the three-dimensional viewing comfort level is improved.

Obviously, various alterations and modifications on the disclosure can be made by the skilled in the art without departing from the spirit and scope of the disclosure. Thus, if these alterations and transformations of the disclosure fall within the scope of the claims of the disclosure and equivalent technologies of the disclosure, the disclosure is intended to include these alterations and transformations.

1. A display device, comprising a display panel and a three-dimensional grating arranged at a light emergent side of the display panel; wherein
the display panel comprises a plurality of pixels and black matrixes, and the pixels comprise a plurality of sub-pixels; and the sub-pixels and the black matrixes are alternately arranged in both row and column directions;
in every column of sub-pixels, sides, connected in the column direction, of the sub-pixels and the black matrixes are aligned to a same straight line;
a view region of the display panel comprises at least two adjacent columns of sub-pixels, and adjacent view regions are respectively configured to display three-dimensional image information corresponding to different viewpoints;
and the three-dimensional grating is configured to form light transmitting regions and light blocking regions alternately arranged in the row direction.

2. The display device according to claim 1, wherein light emitting colors of the sub-pixels adjacent in the row direction are different from each other; and light emitting colors of the sub-pixels adjacent in the column direction are different from each other.

3. The display device according to claim 2, wherein the sub-pixels comprises sub-pixels with all the light emitting colors;
the sub-pixels with different light emitting colors in the sub-pixels are repeatedly arranged according to a same order;
and the sub-pixels with different light emitting colors in the sub-pixels are repeatedly arranged according to a same order.

4. The display device according to claim 1, wherein a width of the light transmitting regions in the row direction are smaller than a width of the light blocking regions in the row direction.

5. The display device according to claim 1, wherein a width of the light transmitting regions in the row direction are smaller than a width of the sub-pixels in the row direction.

6. The display device according to claim 1, wherein a three-dimensional display pixel point comprises three sub-pixels with different light emitting colors, which are arranged in three adjacent rows of sub-pixels and two adjacent columns of sub-pixels, and the three-dimensional display pixel points are configured to display three-dimensional image information;
and a two-dimensional display pixel point comprises three sub-pixels with different light emitting colors, which are arranged in three adjacent columns of sub-pixels and two adjacent rows of sub-pixels, and the two-dimensional display pixel points are configured to display two-dimensional image information.

7. The display device according to claim 6, wherein a ratio of a width of the sub-pixels in the row direction to a width of the sub-pixels in the column direction is 2:3.

8. The display device according to claim 1, wherein the view region comprises two adjacent columns of sub-pixels, and the adjacent view regions are respectively configured to display three-dimensional image information corresponding to a left-eye viewpoint and three-dimensional image information corresponding to a right-eye viewpoint.

9. A three-dimensional display method of the display device according to claim 1, comprising:
controlling the adjacent view regions in the display panel to respectively display the three-dimensional image information corresponding to different viewpoints, and controlling the three-dimensional grating to form the light transmitting regions and the light blocking regions;
changing positions of the light transmitting regions and the light blocking regions in the three-dimensional grating according to a movement of a viewer.

10. A three-dimensional display method of the display device according to claim 1, comprising:
controlling the adjacent view regions in the display panel to respectively display the three-dimensional image information corresponding to different viewpoints, and controlling the three-dimensional grating to form the light transmitting regions and the light blocking regions, wherein positions of the light transmitting regions and the light blocking regions are fixed; and
changing positions of the view regions in the display panel according to a movement of a viewer.
